(19) United States
(12) Patent Application Publication
(10) Pub. No.: US 2024/0351464 A1
(43) Pub. Date: Oct. 24, 2024

(54) CONTROL DEVICE AND CONTROL METHOD

(71) Applicant: TOYOTA JIDOSHA KABUSHIKI KAISHA, Toyota-shi (JP)

(72) Inventors: Chikage KUBO, Tokyo (JP); Masatoshi Terada, Yamato-shi (JP)

(73) Assignee: TOYOTA JIDOSHA KABUSHIKI KAISHA, Toyota-shi (JP)

(21) Appl. No.: 18/638,030

(22) Filed: Apr. 17, 2024

(30) Foreign Application Priority Data
Apr. 19, 2023 (JP) 2023-068709

(51) Int. Cl. B60L 53/62; B60L 53/14; B60L 53/30; B60L 53/36

(52) U.S. Cl. CPC B60L 53/62; B60L 53/14; B60L 53/305; B60L 53/36

(57) ABSTRACT

A control device includes a control unit that acquires a charging standard of a charger when it is detected that a vehicle stops within a predetermined area including a charging station, that determines compatibility between a charging standard of the vehicle and the charging standard of the charger, and that, when it is determined that there is compatibility, displays a location of a charge port of the vehicle on a display screen of the vehicle.

### CROSS-REFERENCE TO RELATED APPLICATION

This application claims priority to Japanese Patent Application No. 2023-068709 filed on Apr. 19, 2023, incorporated herein by reference in its entirety.

### BACKGROUND

### 1. Technical Field

The present disclosure relates to a control device and a control method.

### 2. Description of Related Art

Conventionally, there has been known a technique of displaying information related to vehicle charging. For example, Japanese Unexamined Patent Application Publication No. 10-81157 (JP 10-81157 A) discloses a filler port sign for physically indicating to a driver which side of a body a filler port of a vehicle is provided on. In JP 10-81157 A, the filler port sign is a sticker with an arrow printed thereon, and is affixed to a place easily seen by the driver in a front part of a vehicle cabin.

### SUMMARY

When a battery electric vehicle (which refers to an externally chargeable battery electric vehicle (BEV) or plug-in hybrid electric vehicle (PHEV)) approaches a charging station in order to be charged, a driver sometimes loses track of where on a body a charge port is provided. Accordingly, it is conceivable to apply a charge port sign (filler port sign) as described above. However, when the charge port sign is affixed in front of a driver, such as on a dashboard on a driver-seat side, a display area on the dashboard is occupied, so that a safety problem arises. Moreover, there are also some cases where it is not known if a charging standard of a charging station is compatible with a charging standard of the own vehicle. Accordingly, a driver who drops in at the nearest charging station for the first time may require time to finish locating a charge port and checking charging standard compatibility, to become unable to perform charging depending on the circumstances.

Accordingly, there has been room for improvement in the technique of displaying information related to vehicle charging.

An object of the present disclosure in light of such circumstances is to improve the technique of displaying information related to vehicle charging.

A control device according to an embodiment of the present disclosure is a control device that determines whether or not a charging standard of a charger installed in a charging station is compatible with a charging standard of a vehicle, the control device including a control unit that acquires the charging standard of the charger when it is detected that the vehicle stops within a predetermined area including the charging station, that determines compatibility between the charging standard of the vehicle and the charging standard of the charger, and that, when it is determined that there is compatibility, displays a location of a charge port of the vehicle on a display screen of the vehicle.

A control method according to an embodiment of the present disclosure is a control method executed by a control device that determines whether or not a charging standard of a charger installed in a charging station is compatible with a charging standard of a vehicle, the control method including: acquiring the charging standard of the charger when it is detected that the vehicle stops within a predetermined area including the charging station; determining compatibility between the charging standard of the vehicle and the charging standard of the charger; and when it is determined that there is compatibility, displaying a location of a charge port of the vehicle on a display screen of the vehicle.

According to an embodiment of the present disclosure, the technique of displaying information related to vehicle charging is improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a schematic configuration of a system according to an embodiment of the present disclosure;

FIG. 2 is a flowchart showing operation of a control device;

FIG. 3 is a schematic diagram showing a predetermined area including a charging station; and

FIG. 4 is a schematic diagram showing that information related to vehicle charging is presented through voice interaction.

### DETAILED DESCRIPTION OF EMBODIMENTS

Hereinafter, an embodiment of the present disclosure is described.

### Outline of Embodiment

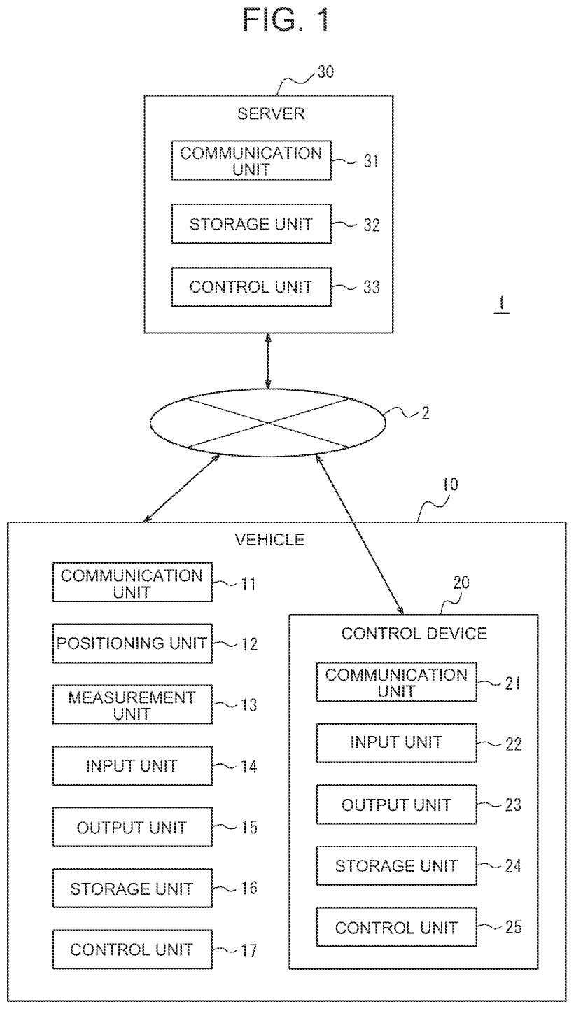

With reference to FIG. 1, an outline of a system 1 according to the embodiment of the present disclosure is described. The system 1 includes a vehicle 10, a control device 20, and a server 30. The vehicle 10, the control device 20, and the server 30 are communicably connected to a network 2 including, for example, the Internet and a mobile communication network or the like.

The vehicle 10 is an automobile that travels by using a motor that is powered by electricity. The automobile is, but is not limited to, an externally chargeable BEV, PHEV, or the like. The number of vehicles 10 included in the system 1 may be arbitrarily set. The vehicle 10 is communicably connected to the control device 20 and the server 30 via the network 2.

The control device 20 is a computer mounted in the vehicle 10 and determines whether or not a charging standard of a charger installed in a charging station is compatible with a charging standard of the vehicle 10. The control device 20 is communicably connected to the vehicle 10 and the server 30 via the network 2.

The server 30 is a computer owned by a charging service provider that centrally manages charging stations located at a plurality of places. The server 30 is communicably connected to the vehicle 10 and the control device 20 via the network 2.

First, an outline of the present embodiment is described, and details will be described later. When it is detected that the vehicle 10 stops within a predetermined area including a charging station, the control device 20 acquires a charging standard of a charger, determines compatibility between the charging standard of the vehicle 10 and the charging standard of the charger 5, and, when it is determined that there is compatibility, displays the location of a charge port of the vehicle 10 on a display screen of the vehicle 10.

As described above, according to the present embodiment, when the vehicle 10 stops within the predetermined area including the charging station, the control device 20 determines compatibility between the charging standard of the charger and the charging standard of the vehicle, and displays, on the display screen of the vehicle 10, a method for making charging possible and the location of the charge port. Accordingly, time and effort taken for a driver him/herself to locate the charge port and check the charging standard compatibility are saved. Hence, the technique of displaying information related to charging of the vehicle 10 is improved, in terms of the probability being increased that the driver of the vehicle 10 can easily use a charging station.

Next, each component of the system 1 is described in detail.

### Configuration of Vehicle

As shown in FIG. 1, the vehicle 10 includes a communication unit 11, a positioning unit 12, a measurement unit 13, an input unit 14, an output unit 15, a storage unit 16, a control unit 17, and the control device 20. A configuration of the control device 20 will be described later.

The communication unit 11 includes one or more communication interfaces connecting to the network 2. The one or more communication interfaces support, but are not limited to, a mobile communication standard such as the 4th generation (4G) or the 5th generation (5G), an in-vehicle network (for example, controller area network (CAN)), or the like. In the present embodiment, the vehicle 10 communicates with the control device 20 and the server 30 via the communication unit 11 and the network 2. The vehicle 10 may communicate with the control device 20 within the vehicle 10 via the communication unit 11, for example, by using the CAN.

The positioning unit 12 includes one or more devices that acquire position information on the vehicle 10. Specifically, the positioning unit 12 includes, for example, a receiver that supports the GPS. However, the one or more devices are not limited to the receiver mentioned above, and the positioning unit 12 may include a receiver that supports an arbitrary satellite positioning system.

The measurement unit 13 includes one or more devices that monitor a vehicle state, such as travel speed, of the vehicle 10. Specifically, the one or more devices include a pressure sensor, an exhaust gas sensor, an acceleration sensor, a gyro sensor, a millimeter-wave radar, an infrared radar, a camera, or the like, and measure and collect data inside and outside the vehicle 10. However, the one or more devices are not limited to those mentioned above.

The input unit 14 includes at least one input interface that can receive an input made by the driver of the vehicle 10. The input interface is, for example, a physical key, a capacitive key, a pointing device, a camera, a touch screen provided integrally with a display of the output unit 15, which will be described below, a microphone to which voice of the driver is input, or the like. However, the input interface is not limited to those mentioned above.

The output unit 15 includes at least one sound output interface that can output sound, and at least one display interface that can display a character or a video. The sound output interface is, for example, a speaker. The display interface is, for example, a display such as an LCD or an organic EL display. The output unit 15 displays a result of determination of whether or not the charging standard of the vehicle 10 and a charging standard of a charger in a charging station are compatible with each other, the location of the charge port of the vehicle 10, a method for using a predetermined conversion adapter, and the like. The sound output interface and the display interface are not limited to those mentioned above.

The storage unit 16 includes one or more memories. The one or more memories include, but are not limited to, for example, a semiconductor memory, a magnetic memory, an optical memory, or the like. Each memory included in the storage unit 16 may function as, for example, a main storage device, a secondary storage device, or a cache memory. The storage unit 16 stores arbitrary information used for operation of the vehicle 10. For example, the storage unit 16 may store a system program, an application program, embedded software, the position (map information) of a charging station located within a region where travel is planned, which is acquired from the server 30, which will be described later, and the like. The information stored in the storage unit 16 may be able to be updated with, for example, information acquired from the network 2 via the communication unit 11.

The control unit 17 includes one or more processors, one or more programmable circuits, one or more dedicated circuits, or a combination thereof. The one or more processors include, but are not limited to, for example, a general-purpose processor such as a central processing unit (CPU) or a graphics processing unit (GPU), or a single-purpose processor dedicated to a specific process. The one or more programmable circuits include, but are not limited to, for example, a field-programmable gate array (FPGA). The one or more dedicated circuits include, but are not limited to, for example, an application specific integrated circuit (ASIC). The control unit 17 controls operation of the entire vehicle 10.

### Configuration of Control Device

As shown in FIG. 1, the control device 20 includes a communication unit 21, an input unit 22, an output unit 23, a storage unit 24, and a control unit 25.

The communication unit 21 includes one or more communication interfaces connecting to the network 2. The one or more communication interfaces support, but are not limited to, for example, a mobile communication standard, a wired local area network (LAN) standard, a wireless LAN standard, or an in-vehicle network (for example, CAN), and may support an arbitrary communication standard. In the present embodiment, the control device 20 communicates with the vehicle 10 and the server 30 via the communication unit 21 and the network 2. The control device 20 may communicate with the vehicle 10 via the communication unit 21, for example, by using the CAN.

The input unit 22 includes at least one input interface that can receive an input made by the driver of the vehicle 10. The input interface is, for example, a physical key, a capacitive key, a pointing device, a camera, a touch screen provided integrally with a display of the output unit 23, which will be described below, a microphone to which voice of the driver is input, or the like. However, the input interface is not limited to those mentioned above.

The output unit 23 includes at least one sound output interface that can output sound, and at least one display interface that can display a character or a video. The sound output interface is, for example, a speaker for responding via voice to an inquiry from the driver. The display interface is, for example, a display such as an LCD or an organic EL display. However, the sound output interface and the display interface are not limited to those mentioned above.

The storage unit 24 includes one or more memories. Each memory included in the storage unit 24 may function as, for example, a main storage device, a secondary storage device, or a cache memory. The storage unit 24 stores arbitrary information used for operation of the control device 20. For example, the storage unit 24 may store beforehand a system program, an application program, a database, the location of the charge port of the vehicle 10, the charging standard of the vehicle 10, and a specification of the predetermined conversion adapter provided for the vehicle 10, and the like. The information stored in the storage unit 24 may be able to be updated with, for example, information acquired from the network 2 via the communication unit 21.

The control unit 25 includes one or more processors, one or more programmable circuits, one or more dedicated circuits, or a combination thereof. The control unit 25 controls operation of the entire control device 20.

### Configuration of Server

As shown in FIG. 1, the server 30 includes a communication unit 31, a storage unit 32, and a control unit 33.

The communication unit 31 includes one or more communication interfaces connecting to the network 2. The one or more communication interfaces support, but are not limited to, for example, a wired LAN standard or a wireless LAN standard, and may support an arbitrary communication standard. In the present embodiment, the server 30 communicates with the vehicle 10 and the control device 20 via the communication unit 31 and the network 2.

The storage unit 32 includes one or more memories. Each memory included in the storage unit 32 may function as, for example, a main storage device, a secondary storage device, or a cache memory. The storage unit 32 stores arbitrary information used for operation of the server 30. For example, the storage unit 32 may store a system program, an application program, a database, information including the positions (map information) of charging stations operated by the charging service provider that owns the server 30, and the like. The information stored in the storage unit 32 may be able to be updated with, for example, information acquired from the network 2 via the communication unit 31.

The control unit 33 includes one or more processors, one or more programmable circuits, one or more dedicated circuits, or a combination thereof. The control unit 33 controls operation of the entire server 30.

### Operation Flow of Control Device

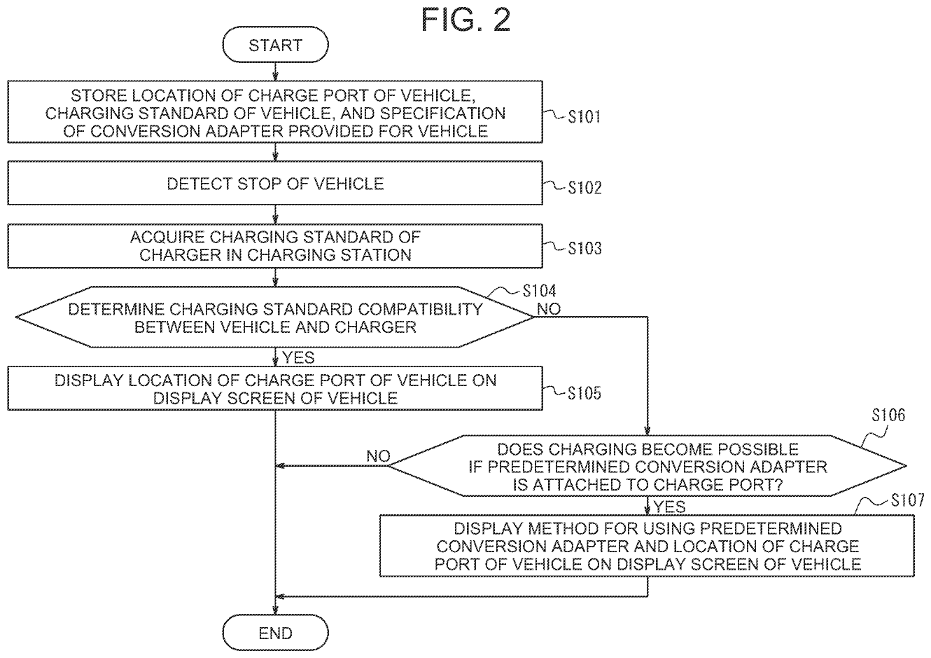

With reference to FIG. 2, operation of the control device 20 according to the present embodiment is described. The operation relates to determination of whether or not a charging standard of a charger installed in a charging station is compatible with the charging standard of the vehicle 10.

Step S101: The storage unit 24 stores the location of the charge port of the vehicle 10, the charging standard of the vehicle 10, and the specification of the predetermined conversion adapter provided for the vehicle 10.

The vehicle 10 includes at least one charge port that supports at least one charging standard among an ordinary-charging standard and one or more fast-charging standards, respectively. The ordinary-charging standard is, but is not limited to, for example, SAEJ1772, which is a standard for ordinary charging adopted in the United States and Japan. The one or more fast-charging standards include, but are not limited to, for example, the CHAdeMO(R) standard, which is a fast-charging standard originated in Japan, the Chinese GB/T standard, and the combined charging system (CCS) standard in Europe and the United States, as well as the Tesla proprietary connector (TPC) standard, which is the North American charging standard, and the like. For example, the vehicle 10 may include two charge ports that support SAEJ1772 and the CHAdeMO standard, respectively.

Step S102: The control unit 17 of the vehicle 10 detects a stop of the vehicle 10 within a predetermined area 3 including a charging station 4.

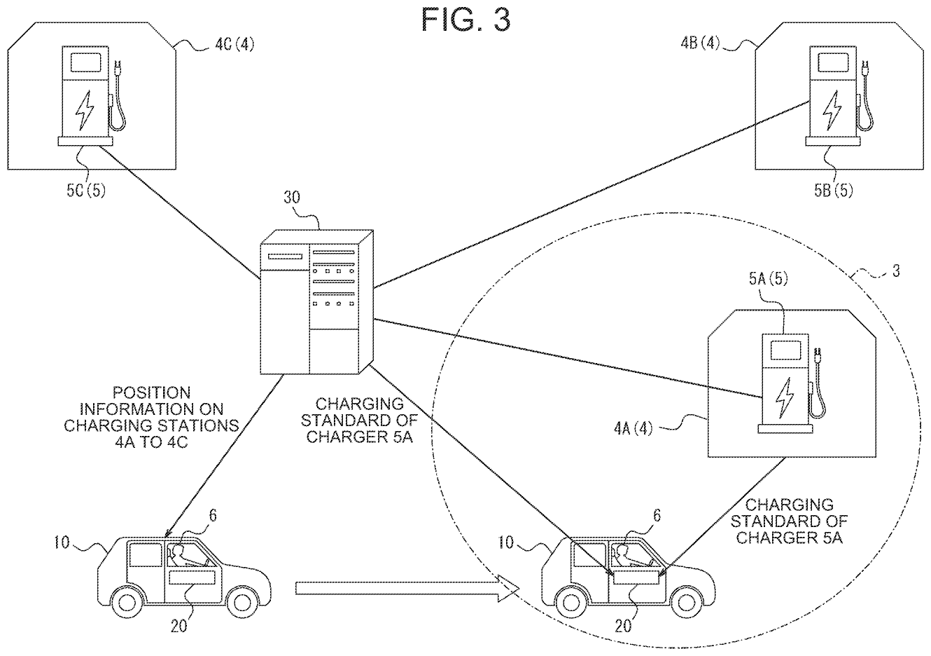

FIG. 3 is a schematic diagram showing the predetermined area 3 including a charging station. As shown in FIG. 3, the vehicle 10 acquires, from the server 30 operated by the charging service provider, position information (map information) on the charging station 4A that is the nearest in distance from the vehicle 10, and enters and stops within the predetermined area 3 including the charging station 4A in order to be charged from a charger 5A. The server 30 centrally manages information on charging stations 4A to 4C operated by the charging service provider.

The stop of the vehicle 10 includes traveling at a predetermined travel speed or lower, traveling slowly, for example, to enter the site of the charging station 4, and the like. The positioning unit 12 measures a position where the vehicle 10 is present. The measurement unit 13 measures the travel speed of the vehicle 10. The control unit 17, when it is detected that the vehicle 10 moves at the predetermined travel speed or lower or stops within the predetermined area 3, transmits the detected information to the control device 20.

Step S103: The control unit 25 acquires a charging standard of the charger 5.

The charger 5 supports any one charging standard among the above-described ordinary-charging standard and one or more fast-charging standards. When the vehicle 10 comes within the predetermined area 3 including the charging station 4, the control unit 17 acquires the charging standard of the charger 5, for example, from the server 30, but the acquisition source is not limited to the server 30. When a QR code (R) indicating the charging standard of the charger 5 is provided at the charging station 4, the charging standard of the charger 5 may be acquired by reading the QR code by using a camera included in the vehicle 10 or the control device 20.

The control unit 25 may automatically start a procedure for determining charging standard compatibility, triggered by the detection of the stop of the vehicle 10 within the predetermined area 3 including the charging station 4, as shown at steps S101 to S103.

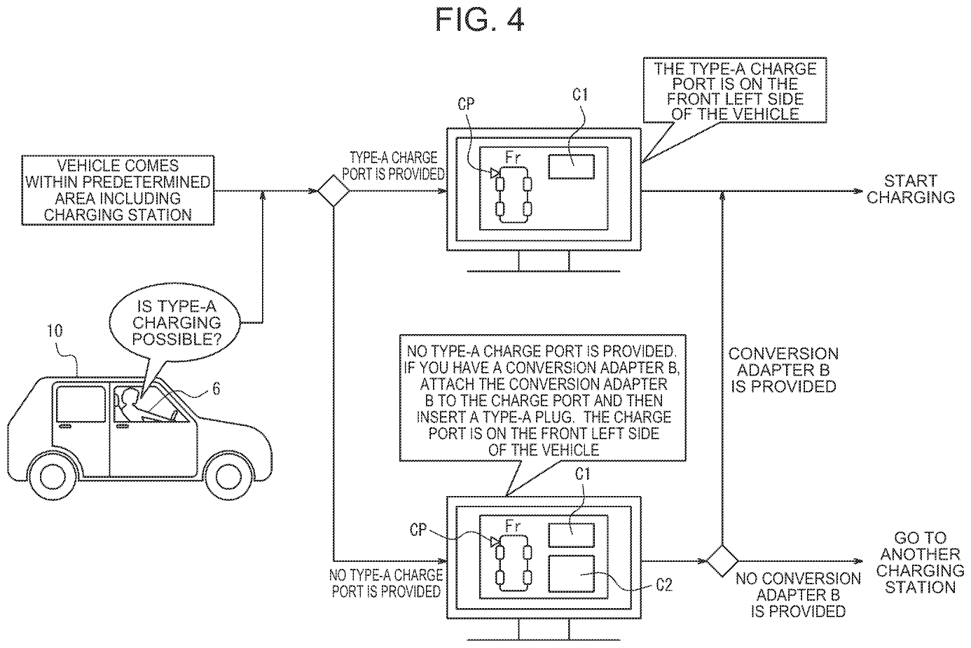

The control device 20 includes the input unit 22 that receives an input from the driver 6 of the vehicle 10 via voice and the output unit 23 that responds to the driver 6 via voice. The control unit 25 may passively start the procedure for determining charging standard compatibility when the input unit 22 receives from the driver 6, via voice, an inquiry about whether or not the charging standard of the charger 5 is compatible with the charging standard of the vehicle 10, as shown in FIG. 4.

Step S104: The control unit 25 determines compatibility between the charging standard of the vehicle 10 and the charging standard of the charger 5.

When the vehicle 10 stops within the predetermined area 3 including the charging station 4, or when the inquiry from the driver 6 is received via voice, the control device 20 acquires the charging standard of the charger 5 and determines whether or not the charging standard of the charger is compatible with the charging standard of the vehicle. Accordingly, time and effort taken for the driver 6 him/herself to locate the charge port and check the charging standard compatibility are saved.

Step S105: When it is determined in step S104 that there is compatibility, the control unit 25 displays a determination result C1 and the location CP of the charge port of the vehicle 10 on the display screen of the vehicle 10.

When it is determined that the charging standard of the charger 5 is compatible with the charging standard of the vehicle 10, the control device 20 displays the location CP of the charge port and the determination result C1 on the display screen of the vehicle 10, as shown on a display screen in FIG. 4. Accordingly, the safety problem that a charge port sign occupies a display area on a dashboard can be solved.

Step S106: When it is determined in step S104 that there is no compatibility, the control unit 25 determines whether or not it becomes possible to charge the vehicle 10 by attaching the predetermined conversion adapter to the charge port of the vehicle 10.

The storage unit 24 stores a specification of a conversion adapter B provided for the vehicle 10. Accordingly, when the conversion adapter B is provided that enables the vehicle 10 to be charged from the charger 5, the control unit 25 can present use of the conversion adapter B.

Step S107: When it is determined in step S106 that it becomes possible to charge the vehicle 10, the control unit 25 displays the determination result C1, a method C2 for using the predetermined conversion adapter, and the location CP of the charge port of the vehicle 10 on the display screen of the vehicle 10.

As shown in FIG. 4, the output unit 23 of the control device may provide the driver 6, via voice, with guidance on the determination result C1 about compatibility, the method C2 for using the predetermined conversion adapter (conversion adapter B), and the location CP of the charge port of the vehicle 10. When the input unit 22 receives from the driver 6, via voice, an input of “Is type-A charging possible?”, the control unit 25 passively determines charging standard compatibility between the vehicle 10 and the charger 5. When the control unit 25 determines that there is charging standard compatibility, the output unit 23 provides, via voice, guidance of “The type-A charge port is on the front left side of the vehicle” and displays, on the display screen, the determination result C1 and the location CP of the charge port. When the control unit 25 determines that there is no charging standard compatibility, guidance of “No type-A charge port is provided” is given via voice, and the determination result C1 is displayed on the display screen. Moreover, when it becomes possible to charge the vehicle 10 by attaching the conversion adapter B to the charge port of the vehicle 10, guidance of “No type-A charge port is provided. If you have a conversion adapter B, attach the conversion adapter B to the charge port and then insert a type-A plug. The charge port is on the front left side of the vehicle” is given via voice, and the determination result C1, the method C2 for using the conversion adapter B, and the location CP of the charge port are displayed on the display screen. According to such a configuration, the control device 20 can enter into the procedure for determining charging standard compatibility in response to an inquiry from the driver 6. In FIG. 4, an oval callout indicates the inquiry via voice from the driver 6, and rectangular callouts indicate the responses via voice from the output unit 23.

As described above, when it is detected that the vehicle 10 stops within the predetermined area 3 including the charging station 4, the control device 20 according to the present embodiment acquires the charging standard of the charger 5, determines compatibility between the charging standard of the vehicle 10 and the charging standard of the charger 5, and, when it is determined that there is compatibility, displays the location of the charge port of the vehicle 10 on the display screen of the vehicle 10.

According to such a configuration, when the vehicle 10 stops within the predetermined area 3 including the charging station 4, the control device 20 determines compatibility between the charging standard of the charger 5 and the charging standard of the vehicle 10 and displays the determination result, the method for making charging possible, and the location of the charge port on the display screen of the vehicle 10. Accordingly, time and effort taken for the driver 6 him/herself to locate the charge port and check the charging standard compatibility are saved. Hence, the technique of displaying information related to charging of the vehicle 10 is improved, in terms of the probability being increased that the driver 6 of the vehicle 10 can easily use the charging station 4.

Although the present disclosure has been described based on the drawings and the embodiment, it should be noted that a person skilled in the art may make various changes and modifications based on the present disclosure. Accordingly, it should be noted that such changes and modifications are included in the scope of the present disclosure. For example, the function and the like included in each constituent unit, each step, or the like can be relocated in such a manner that no logical inconsistency occurs, and a plurality of constituent units, steps, or the like can be combined into one, or may be further divided.

For example, an embodiment is possible in which the configuration and the operation of the control device 20 in the embodiment are distributed among a plurality of computers that can communicate with each other. For example, an embodiment is also possible in which one or some, or all, of the constituent elements of the control device 20 are included in the vehicle 10. A functional unit (communication unit 11, input unit 14, output unit 15, storage unit 16, control unit 17) included in the vehicle 10 may include one or some, or all, of the constituent elements of the control device 20. For example, the input unit 14 of the vehicle 10 may receive an inquiry from the driver 6 via voice, and the output unit 15 may respond to the driver 6 via voice.

For example, an embodiment is also possible in which a general-purpose computer is caused to function as the control device 20 according to the embodiment. Specifically, a program that describes processing contents implementing each function of the control device 20 according to the embodiment is stored in a memory of the general-purpose computer, and the program is read and executed by a processor. Accordingly, the present disclosure can also be implemented as a processor-executable program or a non-transitory computer-readable medium that stores the program.

What is claimed is:

1. A control device that determines whether or not a charging standard of a charger installed in a charging station is compatible with a charging standard of a vehicle, the control device comprising a control unit that acquires the charging standard of the charger when it is detected that the vehicle stops within a predetermined area including the charging station, that determines compatibility between the charging standard of the vehicle and the charging standard of the charger, and that, when it is determined that there is compatibility, displays a location of a charge port of the vehicle on a display screen of the vehicle.

2. The control device according to claim 1, wherein
the charger supports any one charging standard among an ordinary-charging standard and one or more fast-charging standards, and
the vehicle includes at least one charge port that supports at least one charging standard among the ordinary-charging standard and the one or more fast-charging standards, respectively.

3. The control device according to claim 1, further comprising a storage unit that stores the location of the charge port of the vehicle, the charging standard of the vehicle, and a specification of a predetermined conversion adapter provided for the vehicle,
wherein when it is determined that there is no compatibility between the charging standard of the vehicle and the charging standard of the charger, the control unit displays a method for using the predetermined conversion adapter and the location of the charge port of the vehicle on the display screen of the vehicle when it becomes possible to charge the vehicle by attaching the predetermined conversion adapter to the charge port of the vehicle.

4. The control device according to claim 1, further comprising:
an input unit that receives an input from a driver of the vehicle via voice; and
an output unit that responds to the driver via voice, wherein
the input unit receives from the driver, via voice, an inquiry about whether or not the charging standard of the charger is compatible with the charging standard of the vehicle, and
the output unit provides the driver, via voice, with guidance on a determination result about the compatibility, a method for using a predetermined conversion adapter, and the location of the charge port of the vehicle.

5. A control method executed by a control device that determines whether or not a charging standard of a charger installed in a charging station is compatible with a charging standard of a vehicle, the control method comprising:
acquiring the charging standard of the charger when it is detected that the vehicle stops within a predetermined area including the charging station;
determining compatibility between the charging standard of the vehicle and the charging standard of the charger; and
when it is determined that there is compatibility, displaying a location of a charge port of the vehicle on a display screen of the vehicle.
